(19) United States
(12) Patent Application Publication
(10) Pub. No.: US 2015/0326149 A1
(43) Pub. Date: Nov. 12, 2015

(54) METERING DEVICE AND METHOD FOR MANAGING AND PROVIDING COMPARATIVELY SMALL AMOUNT OF ENERGY OBTAINED FROM AN ENERGY GENERATION UNIT

(71) Applicant: Johnson Matthey Public Limited Company, London (GB)

(72) Inventors: Stefan KLUMP, Lichtenfels (DE); Martin RUETTEL, GRUB AM FORST (DE); Klaus van der Linden, Redwitz (DE)

(21) Appl. No.: 14/410,637

(22) PCT Filed: Jul. 4, 2013
(86) PCT No.: PCT/GB2013/051779

§ 371 Date: Dec. 23, 2014

(30) Foreign Application Priority Data
Jul. 4, 2012 (DE) 102012211576.5

(51) Int. Cl. H02N 2/18; G05B 15/02

(52) U.S. Cl. CPC H02N 2/181; G05B 15/02

(57) ABSTRACT

A metering device (2) comprises an energy generation unit (12) for generating comparatively small amounts of energy during an operating cycle; an energy storage unit (24, 26) for buffering the amount of energy generated; a control unit (14) for determining an item of current state information (I); and a processing unit (16) for processing the current state information (I) further, wherein the energy requirement of the control unit (14) and the energy requirement of the display unit (16) are different, and the allocation of the limited amount of energy for the control unit (14) and the processing unit (16) is regulated according to the different energy requirement.

The invention relates to a metering device, such as a metering dispenser, and to a method of managing and providing a comparatively small amount of energy obtained from an energy generation unit.

So-called “energy harvesting” is known for the purpose of supplying electronic structural units with very small amounts of energy in a decentralized manner and in a manner independent of a voltage source. In the case of this energy harvesting, energy provided in the environment, for example mechanical kinetic energy or vibration energy, heat etc., is generally converted into electrical energy by means of suitable energy generators. So-called piezoelectric generators are known for converting mechanical vibration or kinetic energy into electrical energy. These generators convert the mechanical energy into electrical energy using the piezoelectric effect.

On account of the piezoelectric effect, the amounts of energy which can be generated are comparatively small. The amount of energy generated using a piezoelectric generator during an operating cycle, for example a mechanical deflection of a piezoelectric bending transducer, is typically only in the region of a few 100 μJ. If complete autonomous energy supply of electronic structural units is sought, high energy efficiency is required. An autonomous energy supply makes it possible to dispense with voltage sources such as a mains supply or else a battery and to simultaneously ensure the functionality of the device.

Metering dispensers, in particular hand-operated medicament dispensers for medical preparations, for example nasal sprays or asthma sprays for inhaling a medical medicament, usually have a supply store (ampoule), in particular an exchangeable supply store, containing the medical medicament which is atomized by means of an atomizer nozzle, for example. In order to provide the user with information relating to the remaining amount which is still available, for example, such metering dispensers often have a display element which indicates, for example, the available remaining amount or the number of doses which have already been administered or the number of doses which are still available (see WO 2007/137991 A1 and US 2005/0284471 for example). In such metering dispensers, for example nasal sprays, asthma sprays or else dispensers for eyedrops, the medicament is dispensed, in particular in the case of favourable disposable medicament dispensers, by the user mechanically actuating a metering button.

On the basis of this, the invention is based on the object of enabling a hand-operated medicament dispenser as described hereinabove, for autonomous operation using an energy generation unit according to the energy harvesting principle without an additional voltage source, such as a battery or mains connection, and with a high level of energy efficiency.

The object is achieved, according to the invention, by an apparatus having the features of claim 1 and with a method having the features of claim 17. The features and preferred developments stated with respect to the apparatus can analogously also be applied to the method.

For this purpose, the metering device, such as a hand-operated metering and medicament dispenser, comprises an energy generation unit based on the energy harvesting principle for generating very small amounts of energy. In particular, the energy generation unit can comprise at least one piezogenerator. The metering device also comprises an energy storage unit for buffering the amount of energy generated. The metering device also comprises a control unit for determining an item of current state information relating to the metering device, such as a counter reading, for example the number of doses which have already been administered or else the amount which has been administered or the remaining amount or else the number of remaining doses. The metering device finally also comprises a processing unit in which the current state information determined by the control unit is processed further. In this case, the further processing unit can be a display unit, in particular. The display unit preferably has a bistable display element, such as a bistable LCD display. This is because energy is needed only to change the display in the case of such a bistable display element. The information displayed once is retained until the next change. Such a bistable display element is therefore particularly energy-efficient.

The energy consumption of the control unit for determining the current state information and the energy consumption of the processing unit are usually very different and are also partially offset in time within an operating cycle. In order to enable efficient energy management, the present invention provides for the allocation of the limited amount of energy available for a predefined operating cycle for the control unit, on the one hand, and for the processing unit, on the other hand, to be regulated according to their different energy requirement. This should be understood as meaning that the energy provided for the different units for each operating cycle is preferably limited, both in terms of time and in terms of amount, in such a manner that, on the one hand, the functionality of the respective unit is ensured without simultaneously impairing the functionality of the other unit. Without regulation, there would otherwise be the risk of the one unit, in particular the control unit, already consuming the available amount of energy at the beginning of an operating cycle before the display unit actually starts its work.

In this case, an operating cycle is understood as meaning a sequence of permanently predefined operating steps. The operating cycle usually begins with actuation of the metering device or at least of the energy generation unit and a sequence of operating steps which is triggered thereby in the control unit and the display unit. In the case of a medicament dispenser, every manual actuation of the metering button starts such an operating cycle. Therefore, only the amount of energy generated at the start of the operating cycle by actuating the energy generation unit (e.g. piezogenerator) is available during an operating cycle.

In a preferred refinement, an actuating element, in particular a metering button which is connected to the energy generation unit, is therefore also accordingly provided. For energy generation which is as efficient as possible, the energy generation unit is preferably designed according to one of the embodiment variants described in WO 2013/083990 A1. The disclosure content of this application is hereby concomitantly included in the subject matter of the present application.

With regard to the sought regulation and distribution of the available energy, the energy storage unit comprises a first energy store and a second energy store which are respectively connected only to the control unit and the processing unit for the purpose of supplying energy thereto. This ensures that the amount of energy provided is kept available for each unit and is not consumed by the other unit, for instance.

In this case, the energy stores are preferably formed by low-loss capacitors.

In order to take into account the different energy requirement of the two units, the metering device is expediently designed, when in use, to unevenly divide the amount of energy generated by the energy storage unit in an operating cycle among the at least two energy stores. Therefore, the different energy requirement has already been taken into account when feeding the energy stores.

In order to achieve this, a power splitter is provided according to a first embodiment variant for the purpose of dividing the amount of energy generated for each operating cycle. In this case, the power splitter or energy splitter preferably consists of two diodes which are connected upstream of the two energy stores arranged in a parallel manner. The diodes prevent voltage equalization between the energy stores and thus prevent the energy contained in one capacitor flowing back into the other capacitor.

According to one preferred alternative, the energy generation unit comprises two energy generators which are each associated with only one of the respective units. The two energy generators are also expediently designed to generate different amounts of energy according to the different energy requirement. Therefore, the energy generators generally have a different design.

The fact that the electronic units, that is to say the control unit on the one hand and the display unit on the other hand, do not have to be permanently supplied with energy is particularly important overall for the operation of the apparatus. That is to say, the control unit is, in principle, switched off when it has determined the current state information. At the same time, however, it is necessary for the current state information to be retained. This information is therefore expediently stored in a non-volatile memory.

The energy requirement of the control unit for determining the current state information is usually considerably higher than the energy requirement of the processing unit if using a bistable display element, in particular a bistable LCD display, which is preferably used. However, this is relatively sluggish, that is to say requires more time than the control unit. It is generally necessary to first of all erase the old display content before displaying the new display content. Expedient developments accordingly provide for the energy for the control unit to only be provided for a shorter time than for the display within an operating cycle and for the control unit to already be deactivated, while the display unit is still active. In this case, deactivation is understood as meaning, for example, the transition to a standby mode or else the complete switching-off of the control unit. In this case, an activated display unit is understood as meaning a situation in which the current state information provided by the control unit is preprocessed by the display unit for display on the display element. After the display content has been displayed, no more energy is required on account of the design as a bistable display element.

Provision is also made for the control unit, when in use, to determine the current state information at the beginning of the operating cycle, to write said information to the non-volatile memory and to simultaneously output an erase signal to the display unit in order to erase a preceding item of state information displayed there. In order to save energy, provision is also made for the control unit, when in use, to temporarily change to a mode, in particular a standby mode, with an at least reduced energy consumption for a predefined period of time, which is permanently predefined for example or is variable on the basis of feedback from the display unit, during the erase operation and to then be activated again. That is to say, the control unit first of all emits an erase signal to the display unit before it then forwards a new signal containing the current state information to the display unit in a subsequent step after the standby mode.

These signals are generally converted into control signals for the display element (LCD display) using a driver or a so-called driver circuit of the display unit.

In order that the invention may be more fully understood, embodiments thereof will now be described by way of illustration only and with reference to the accompanying drawings, in which:

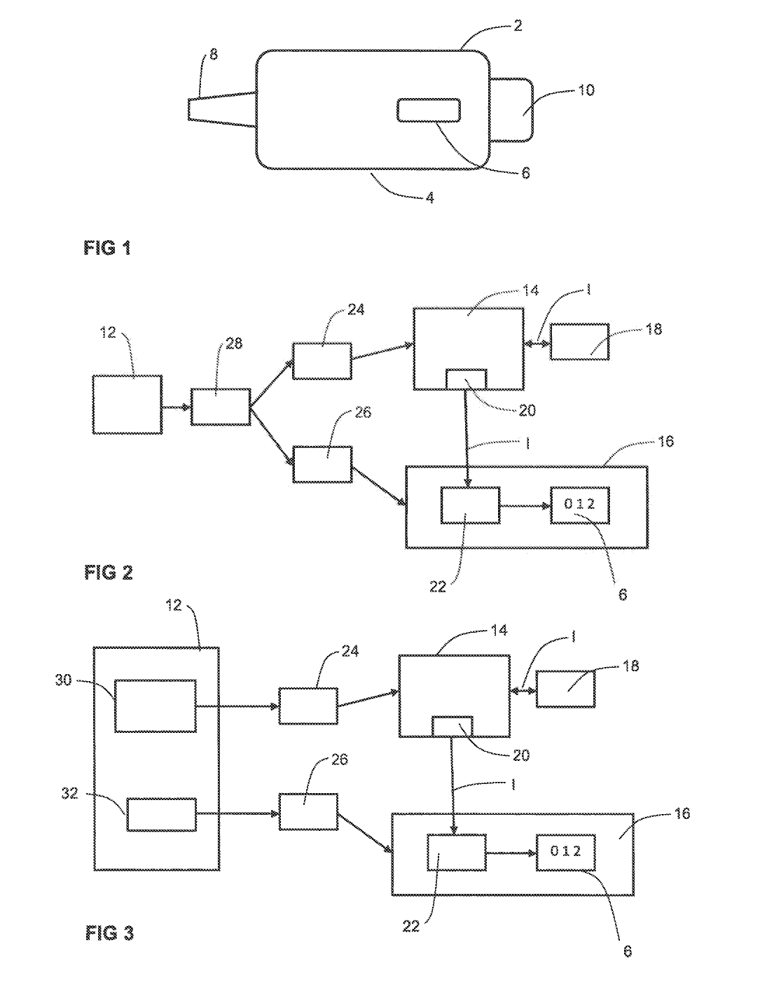

FIG. 1 shows a highly simplified side view of a medicament dispenser with an integrated display element;

FIG. 2 shows a block diagram according to a first alternative for explaining the functional structure of the apparatus; and

FIG. 3 shows a block diagram of a second alternative for explaining the functional structure.

The metering or medicament dispenser 2 illustrated in FIG. 1 comprises a housing 4 in which a display element 6, which can be read from the outside is integrated. On one of its end faces, the medicament dispenser 2 has a metering element 8 which, in the case of a nasal spray or else of an asthma spray for example, is in the form of an atomizer. At the end opposite the metering element 8, the medicament dispenser 2 has a metering button 10 as an actuating element. A storage container for a substance to be metered, for example an ampoule with a liquid medicament, is contained inside the housing.

In order to dispense the medicament, the medicament dispenser 2 is manually actuated by pressing the metering button 10. This mechanical actuation causes, on the one hand, a predetermined dose amount of the medicament to be dispensed via the metering element 8. At the same time, the actuation of the metering button 10 is evaluated in order to determine an item of state information I, namely an item of information relating to the volume of medicament available in the storage container. In this case, the state information is, in particular, a count value relating to the metering units which still remain (one metering unit corresponds to one actuation of the metering button 10) or else the number of metering units which have already been given, for example. This state information I is then displayed on the display element 6.

The medicament dispenser 2 is an energy-autonomous device which does not have a mains connection or a battery for supplying energy. The energy is supplied solely by an energy generation unit 12 comprising a piezogenerator on the basis of so-called energy harvesting. In order to also permanently ensure reliable functionality of the entire apparatus, the medicament dispenser 2 has special measures for high energy efficiency, as explained in more detail below using FIGS. 1 and 2.

In both embodiment variants, a control unit 14 for determining the current state information I and, as a processing unit, a display unit 16, which displays the state information I determined by the control unit 14 on the display element 6, are arranged. The display element 6 is part of the display unit 16 and is a bistable LCD display, in particular.

The control unit 14 is an electronic circuit which, in the case of the medicament dispenser 2 described with regard to FIG. 1, determines and outputs a current count value as the current state information I. A non-volatile memory 18 which stores the respective current state information I is associated with the control unit 14. On account of the energy-autonomous operation, the control unit 14 is activated only when the metering button 10 is actuated. Otherwise, it is in the switched-off state. In addition to the non-volatile memory 18, a volatile memory in the form of a storage register 20 is also arranged inside the control unit 14 in the exemplary embodiment.

The control unit 14 is connected to the display unit 16 for the purpose of determining a signal which contains information relating to the display content and, in particular, the state information I. This information is preprocessed by a driver element 22 in the form of a driver circuit in order to pass a corresponding signal to the display element 6. Only a small amount of energy is required for the display unit 16 on account of the configuration of the display element 6 as a bistable numerical display in the manner of a so-called “electronic paper”. At the same time, a considerably larger proportion of the total energy required for each operating cycle is consumed by the circuit of the control unit 14. In the present case, an operating cycle is understood as meaning the cycle beginning with the actuation of the metering button 10 until the display of the new current state information I on the display element 6.

In order to take this different energy requirement into account, a first energy store 24 is associated with the control unit 14 and a second energy store 26 is associated with the display unit 16 in both variants according to FIGS. 2 and 3. In this case, the two units 14, 16 can obtain energy only from the energy stores 24, 26 associated with them. Energy balancing between the energy stores 24, 26 is not possible. The energy stores 24, 26 are in the form of capacitors, in particular. The energy provided by the energy generation unit 12 is divided among the two energy stores 24, 26 and is preferably distributed asymmetrically, that is to say not identically, according to the different energy requirement of the units 14, 16.

In the exemplary embodiment in FIG. 2, the asymmetric distribution of energy is effected by a power splitter 28 which is connected downstream of the energy generation unit 12 and distributes the energy generated by the latter to the two energy stores 24, 26. In terms of circuitry, the power splitter 28 here consists of two diodes, for example, which ensure the suitable distribution. The energy generation unit 12 comprises a single piezogenerator in which the electrical energy is generated using the piezoelectric effect. The piezogenerator is activated upon the actuation of the metering button 10.

In contrast to this, in the exemplary embodiment in FIG. 3, the energy generation unit 12 is formed by a first energy generator 30 and a second energy generator 32 both of which are in the form of a piezogenerator. The two energy generators 30, 32 are designed, for example, to generate different amounts of energy per operating cycle. Each energy generator 30, 32 supplies only the energy store 24, 26 respectively associated with it. No balancing between the energy stores 24, 26 is enabled here either.

This strict separation of the two energy stores 24, 26 and their association with the two units 14, 16 ensure reliable operation without the need for a battery.

In order to keep the energy consumption as low as possible during an operating cycle, the following steps are carried out when executing an operating cycle:

In the first step, a predefined very small amount of energy in the region of a few 100 μJ is generated by the energy generation unit 12 by the actuation of the metering button 10 and is divided among the two energy stores 24, 26;

In the second step, the control circuit begins its work. It first of all reads the state information (last counter reading) last stored in the non-volatile memory 18 and determines the current state information I. In particular, it increases or reduces the count value by a unit and stores this new value forming the current state information I in the non-volatile memory 18 again;

In the third step, the control unit 14 emits an erase signal to the display unit 16, with the result that data for resetting and erasing the display element 6 are loaded into the driver element 22;

Since the resetting operation takes a certain amount of time, the control unit 14 is changed to a state with a reduced energy consumption, for example a standby mode, or else is completely switched off in a fourth step for the purpose of saving energy. After the expiry of a predetermined time which is firmly selected, for example, or after a corresponding trigger signal from the display unit 16 indicating that the resetting operation has ended, the control unit 14 is activated again and now forwards the current state information I (current count value) to the display unit 16 as a signal; and

In the fifth step, the control unit 14 is then changed to a state with a reduced energy consumption again, for example is switched off. Only the storage register still remains in the active state for the time being, with the result that the display unit 16 still has the correct control signals for displaying the current state information I for a sufficiently long time. At this time, the energy from the first energy store 24 may then have been consumed.

In a parallel manner, the display unit 16 continues to be supplied with energy from the second energy store 26 in order to give the display unit 16 sufficient time to display the new current state information I.

The special structure with the two energy stores 24, 26 blocked from one another therefore ensures that, despite a different energy requirement and also at different times, both units 14, 16 are reliably supplied with the limited amount of energy provided for each operating cycle. Charge balancing between the two stores is ensured by the selected structure, for example by the two diodes of the power splitter 28 in variant 1 or by the two separate energy generators 30, 32.

In the application of a medicament dispenser 2 described with respect to FIG. 1, permanent functionality is therefore provided. Possible self-discharge of a battery with a corresponding required battery change is no longer a concern. Storage stability is only dependent on the material (medicament) to be metered. Disposal is also considerably simplified as a result of the omission of the battery.

### LIST OF REFERENCE SYMBOLS

2 Medicament dispenser
4 Housing
6 Display element
8 Metering element
10 Metering button
12 Energy generation unit
14 Control unit
16 Display unit
18 Non-volatile memory
20 Storage register
22 Driver element
23 Energy storage unit
24 First energy store
26 Second energy store
28 Power splitter
30 First energy generator
32 Second energy generator
I State information

1. A metering device comprising an energy generation unit for generating comparatively small amounts of energy during an operating cycle; an energy storage unit for buffering the amount of energy generated; a control unit for determining an item of current state information (I); and a processing unit for processing the current state information (I) further, wherein the processing unit comprises a display unit and the energy requirement of the control unit and the energy requirement of the display unit are different, and the allocation of energy for the control unit and the processing unit is regulated according to the different energy requirement.

2. The metering device of claim 1, wherein the metering device is a metering dispenser.

3. The metering device of claim 1, wherein the energy generation unit comprises a piezogenerator.

4. The metering device of claim 1, wherein the processing unit is a display unit.

5. The metering device according to claim 1, further comprising an actuating element for activating the operating cycle, the actuating element being connected to the energy generation unit in such a manner that, for every actuation, the energy generation unit is used to generate a limited amount of energy which is available for the operating cycle.

6. The metering device according to claim 1, wherein the energy storage unit comprises a first energy store and a second energy store, the control unit being connected only to the first energy store and the display unit being connected only to the second energy store for the purpose of supplying energy.

7. The metering device of claim 6, arranged, when in use, to unevenly divide the amount of energy generated by the energy generation unit among the energy stores.

8. The metering device of claim 6, further comprising a power splitter for unevenly dividing the amount of energy generated.

9. The metering device of claim 6, wherein the energy generation unit has a first energy generator and a second energy generator, the first energy generator feeding only the first energy store and the second energy generator feeding only the second energy store.

10. The metering device according to claim 1 further comprising a non-volatile memory for storing the current state information (I).

11. The metering device according to claim 1, arranged, when in use, so that energy is provided for the control unit for a shorter time than for the display unit during an operating cycle and the control unit is already deactivated, while the display unit is still active.

12. The metering device according to claim 6, arranged, when in use, so that the amount of energy provided for the control unit for each operating cycle is such that the deactivation is effected as a result of the energy reserve in the first energy store being depleted.

13. The metering device according to claim 6, arranged, when in use, so that a larger amount of energy is stored in the first energy store than in the second energy store for each operating cycle.

14. The metering device according to claim 1, arranged, when in use, so that, at the beginning of the operating cycle, the control unit determines the current operating state (I) and outputs an erase signal to the display unit in order to erase a preceding item of current state information.

15. The metering device of claim 14, arranged, when in use, so that, during the operating cycle, the control unit is temporarily changed to a standby mode for a predefined period of time during erasure and is then reactivated.

16. The metering device according to claim 1, wherein the item of current state information (I) is a counter reading.

17. A method for managing and providing comparatively small amounts of energy in a metering device, which energy being obtained from an energy generation unit in an operating cycle for supplying energy to a control unit and to a processing unit connected to the control unit, the control unit being designed, when in use, to determine an item of current state information (I) and the processing unit being designed, when in use, to process the current state information (I) further, the control unit and the processing unit having a different energy requirement, and the allocation of the limited amount of energy obtained from the energy generation unit for the control unit and the processing unit being regulated according to the different energy requirement.
